(19) United States
(12) Patent Application Publication
(10) Pub. No.: US 2009/0055854 A1
(43) Pub. Date: Feb. 26, 2009

(54) METHODS AND APPARATUS FOR COOPERATOR INSTALLED METERS

(76) Inventors: David Howell Wright, Safety Harbor, FL (US); Christen Voss Nielsen, Palm Harbor, FL (US); Robert Joel Stokes, Palm Harbor, FL (US); Arun Ramaswamy, Tampa, FL (US)

Correspondence Address: Hanley, Flight & Zimmerman, LLC, 150 S. Wacker Dr. Suite 2100, Chicago, IL, 60606, US

(21) Appl. No.: 12/088,802

(22) PCT Filed: May 18, 2007
(86) PCT No.: PCT/US2007/011894

§ 371 Date: Jun. 16, 2008

Related U.S. Application Data
(60) Provisional application No. 60/801,336, filed on May 18, 2006.

(51) Int. Cl. H04N 7/16

(52) U.S. Cl. 725/14

(57) ABSTRACT

Methods and apparatus for cooperator installed meters are disclosed. An example method includes receiving audience information, configuring the audience meter based on the audience information, placing the audience meter in a sleep mode, and shipping the audience meter to a location associated with the audience information.

### CROSS REFERENCE TO RELATED APPLICATIONS

This application claims priority from U.S. Provisional Application Ser. No. 60/801,336, filed May 18, 2006, and which is hereby incorporated by reference in its entirety.

### FIELD OF THE DISCLOSURE

This disclosure relates generally to audience measurement systems and, more particularly, to methods and apparatus for cooperator installed meters.

### BACKGROUND

The demographics of a television viewing audience are used by television program producers to improve the marketability of their television programming and determine a best price for advertising during such programming. In addition, accurate television viewing demographics allow advertisers to target commercial content to desired segments of the population.

In order to determine these demographics, an audience measurement company may enlist a plurality of television viewers as panelists. The viewing habits of the enlisted viewers as well as demographic data about the enlisted viewers is collected and used to statistically determine the demographics of a television viewing audience.

One aspect of audience measurement involves determining the identity of the programming being displayed on a television. Some conventional audience measurement systems use channel detection to identify and control the channel to which a television set is tuned. This channel information may then be combined with programming information (e.g., a program schedule) to identify the program that was being displayed on the television while the television was tuned to the detected channel.

In addition to detecting a channel to which a television is tuned, channel detection systems are used to detect a channel change event in which a television stops displaying programming associated with a first channel and begins displaying programming associated with a second channel. Because a channel change event corresponds to a change in the programming being displayed to the programming audience, a channel change event may be used as a trigger for performing one or more methods for obtaining identification data about the new programming being displayed to the audience and/or for time stamping a recorded data entry associated with the channel change.

In addition, a channel change event may correspond with a change in the audience membership, and therefore, may also be used to trigger a method for capturing information about the audience composition. For example, audience measurement systems may include a device, such as a people meter (PM), having a set of input keys, each assigned to represent a single viewer. The PM may be adapted to capture information about the audience by prompting the audience members to indicate that they are present in the viewing audience by, for example, pressing their assigned input key on the PM. Using a channel change event as a trigger for PM prompting allows for the accurate recording of changes in the size and/or membership of the audience that may result from the channel change event or that may have caused the channel change event.

Audience members may use a television to consume media from various alternate sources. For example, audience members may use a television for watching satellite, cable, IPTV and/or RF television programming, Internet browsing, gaming, gambling, shopping, and/or video on demand, to name a few. Measurement of user consumption of and/or exposure to media content from these sources is of interest to the provider of such media content.

### BRIEF DESCRIPTION OF THE DRAWINGS

FIG. 1 illustrates an example system for collecting media exposure information and example households in which audience members may be exposed to media content.

FIG. 2 is a block diagram of an example metering system coupled to an example home entertainment system.

FIG. 3 is a block diagram of an example implementation of the example people meter device of FIG. 2.

FIG. 4 is a block diagram of an example implementation of the example people meter device of FIG. 3.

FIG. 5 illustrates example audio and/or video messages for use with the example people meter devices of FIGS. 2, 3 and/or 4.

FIGS. 6 and 7 are a flow diagrams illustrating example processes to configure the example people meter of FIGS. 2, 3, and/or 4 prior to delivery to a cooperator.

FIGS. 8A and 8B are flow diagrams representative of example machine accessible instructions which may be executed to setup and configure the example people meters of FIGS. 2, 3, and/or 4 after arrival at a household to be monitored.

FIG. 9 is a flow diagram representative of example machine accessible instructions which may be executed to update the example people meter of FIGS. 2, 3, and/or 4.

### DETAILED DESCRIPTION

As used herein, the term “meter” refers to a device to collect audience measurement data. Audience measurement data may include, for example, tuning information, program identification codes, program signatures, geographic location information, program identification information, and/or audience member composition data. A meter may be a people meter (PM) which collects audience composition information (e.g., audience member identities), and/or a content meter which is structured to identify media content to which a monitored audience is exposed. A portable people meter (PPM) is a type of PM worn by a monitored audience member (e.g., a panelist). Content meters, PMs and PPMs are all example types of meters.

In general, the example methods and apparatus illustrated herein may be used to enable selected panelists to install, configure, and/or use a meter without assistance from field service personnel. Audience members that install such meters themselves (referred to herein as “cooperators”) enable audience data collection companies to redirect resources that would otherwise be spent on hiring and maintaining a fleet of field service representatives. In addition to reducing and/or eliminating the need for field service representatives, additional cost savings are realized due to lower demands for capital assets (fleet vehicles), fuel costs, and associated insurance costs.

The example methods and apparatus described herein may be well suited for particular demographic groups, such as persons having technological backgrounds and/or age categories of people with greater technological comfort and/or familiarity. More specifically, some meters require hardwire interfaces to televisions, digital video disk (DVD) players, set-top boxes (STBs), and/or splitters, as discussed in further detail below, and thus can most easily be installed by persons with a certain level of comfort with technology. On the other hand, non-cabled meters do not require a physical connection to any home entertainment device and may not require installation skills beyond plugging the meter into an electrical outlet for power. Thus, non-cabled meters require virtually no technical aptitude for installation. The non-cabled meters are particularly well suited for cooperators having generally less exposure to audio/visual (A/V) technology than other groups of cooperators. For example, elderly persons may be generally more comfortable with the non-cabled PM approach.

In the illustrated examples, candidates for the cooperator installed meters are selected by an audience measurement company, in part, based on telephone interviews with various households. During the telephone interview process (also referred to herein as the recruitment process), selected candidates are offered an opportunity to participate in a media monitoring program. In exchange for allowing disclosure and monitoring of participant viewing habits, such programs may provide the participants with compensation, such as monetary or other incentives. Candidate information collected during the recruitment process typically includes, but is not limited to, name, age, sex, employment status, employment field, hobbies, and multimedia viewing preferences. If selected, the candidate becomes a cooperator having responsibilities including, for example, receiving the meter (by mail, FedEx®, UPS®, or other courier), installing the meter, confirming that the meter is working properly, and learning how to use the meter properly. Therefore, rather than dispensing field service representatives to perform meter installation, setup, configuration, and/or training, the audience measurement company delivers (or has a third party deliver) a meter which provides instructions and/or assistance to the cooperator/panelist in the form of audio and/or visual prompting, as discussed in further detail below.

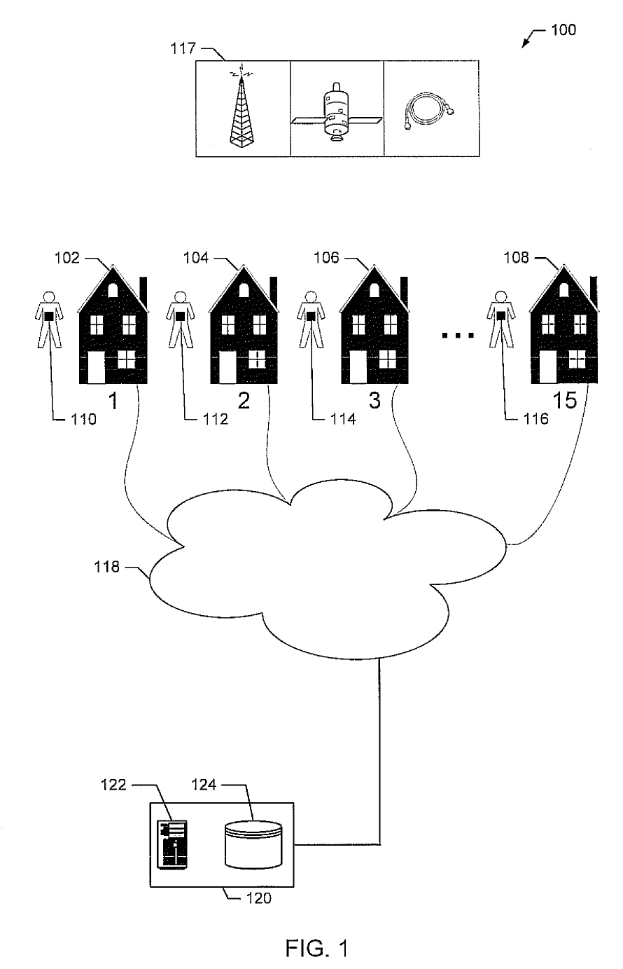

Turning to FIG. 1, for purposes of clarity the example methods and apparatus are described herein with respect to an example geographic area 100 including a number of households 102, 104, 106, 108. Because of the difficulty of applying field service personnel resources to small markets, an example geographic area 100 containing relatively few households is particularly well suited for the methods and apparatus described herein. However, the systems, methods, and apparatus described herein may be applied to any size market. Each household 102, 104, 106, 108 may include any type of meter including, but not limited to, hardwired meters, and/or wireless meters. These meters may include one or more of content meter(s), people meter(s), and/or portable people meter(s) (e.g., PPMs 110, 112, 114, 116, which are worn by members of the selected household 102, 104, 106, 108). The meter(s) may include various sensors to detect A/V signals, radio frequency (RF) signals, ultrasonic (US) signals, infrared (IR) signals, people in a room, and/or acoustic signals, such as audio signals emitted by a television and/or audience member voice signals spoken by persons in the viewer's household.

Each household may receive media from various content providers 117 including, but not limited to, satellite providers, RF broadcast stations, Internet providers, and cable providers. Such media may be digital media, analog media, or both. Media content may include, but is not limited to music radio, talk radio, television programs, premium channel programs, Internet services, video on demand services, gambling, home shopping, and/or video games. Information collected by the meters (e.g., one or more PMs and/or one or more PPMs 110, 112, 114, 116) may be provided to a central home processing system (not shown). The home processing system may be communicatively coupled to the meter(s). For example, the meter may be communicatively connected to a network 118, discussed in further detail below, to transfer collected information from the example households 102, 104, 106, 108 to a central facility 120. As another example, a home processing system may include one or more docking stations (not shown) configured to receive PPM(s) 110, 112, 114, 116 and communicatively couple the PPM(s) to the home processing system. In such an arrangement, audience members may periodically (e.g., nightly) place the PPM(s) 110, 112, 114, 116 in the docking stations to enable the home processing system to obtain collected media monitoring information (e.g., geographic location (e.g., GPS) information, motion and/or travel information, and/or any other information stored on the PPM(s) 110, 112, 114, 116). Additionally, the docking stations may charge a battery of each of the PPMs while the corresponding PPMs are docked thereto.

To transfer data from the households 102, 104, 106, 108, the network 118 of the illustrated example communicatively couples the central facility 120 and the docking stations of the household. The network 118 may be implemented using any suitable communication interface including, for example, a telephone system, a cable system, a satellite system, a cellular communication system, AC power lines, a network, the Internet, etc. As discussed in further detail below, the example meters may include a communication interface communicatively connected to a telephone system (e.g., plain old telephone system (POTS)), an Internet connection, a cable service provider, and/or include an on-board wireless (e.g., cellular) telephone transceiver (e.g., the meter may be integrated in a cell phone). The central facility 120 is remotely located from the households 102, 104, 106, 108 and is communicatively coupled to other monitored sites (e.g., other households) via the network 118. The central facility 120 may obtain audience measurement information, including any or all of tuning information, program identification information, program identification codes, program signatures, audience member identification information, media exposure data, media consumption data, media monitoring data, geographic location information (e.g., GPS data), motion and/or travel information (e.g., traveled paths of PPMs), and/or any other monitoring data that is collected by the meters. Monitored data that is collected by the various households may contain timestamps, which allow the central facility 120 to compare the timestamped data (e.g., channel tuning information, signatures, etc.) against reference information (e.g., program schedules, signature databases, etc.) to determine particular broadcast media consumed by and/or exposed to members of the various households 102, 104, 106, 108.

In an example implementation, the central facility 120 includes a server 122 (e.g., a central processor system) and a database 124. The database 124 may be implemented using any suitable memory and/or data storage apparatus and techniques. The server 122 may be implemented using, for example, a processor system, personal computer, or server that is configured to store information collected from the meters (e.g., the PPM(s) 110, 112, 114, 116 and/or the PM(s)) in the database 124 and to analyze the stored information. In addition, the server 122 may be configured to generate calibration information for the meter based on user demographic data, audio information and/or audio samples collected during an acoustic characterization process or calibration process performed within the households 102, 104, 106, 108. For example, communication via the example network 118 is bidirectional, thereby permitting updates to be applied to any meter(s) available to the network. As discussed in further detail below, such updates may include prompting timing schedules for the meter(s), birthday announcements for the cooperators, and/or status updates regarding participant rewards earned for compliance with viewing rules.

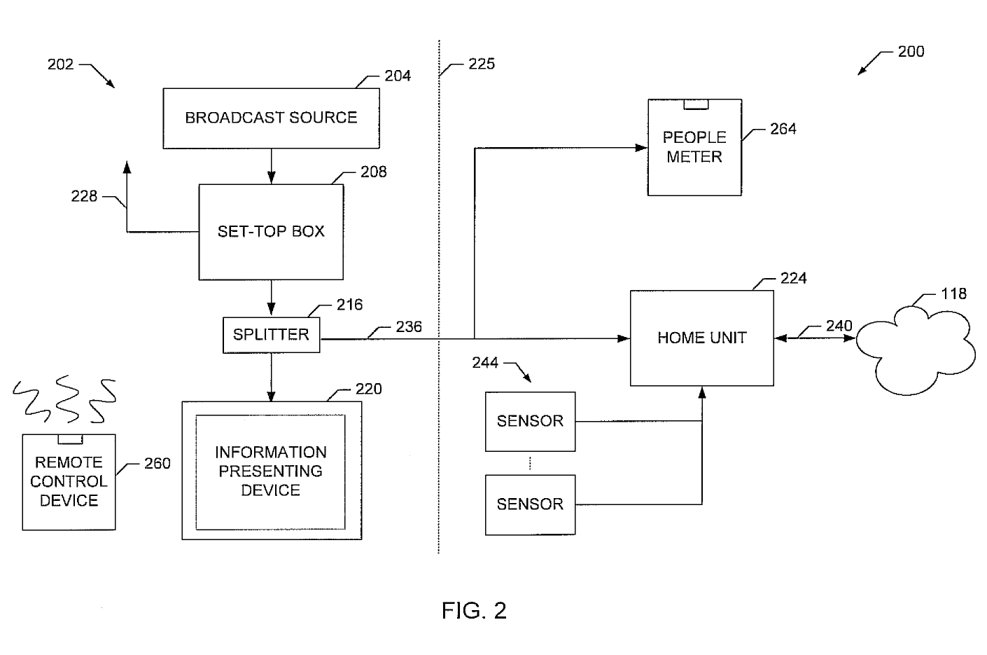

An example local metering system 200 capable of providing viewing and/or metering information for program content consumed and/or exposed to household members via an example home entertainment system 202 is illustrated in FIG. 2. The example home entertainment system 202 of FIG. 2 includes a broadcast source 204, an STB 208, a signal splitter 216 and a digital or analog information presenting device 220, such as a television. The example local metering system 200 includes at least two meters, namely a home unit 224 and a people meter 264. The components of the home entertainment system 202 and the local metering system 200 may be connected in any manner including that shown in FIG. 2. For example, in a statistically selected household having one or more home entertainment systems 202, the home unit 224 may be implemented as a single home unit and one or more site units (not shown). In such a configuration, the site units are meters that collect audience measurement data at one or more locations (e.g., the PM 264 and/or a PPM may be site units) and forwards the collected data to the home unit. The home unit performs the functions of storing data collected by the site units and forwarding the stored data to a central facility (such as the central facility 120 of FIG. 1 discussed above) for subsequent processing. Each site unit associated with a corresponding home entertainment system 202 and/or, in the case of a PPM, a corresponding audience member, and performs the functions of collecting audience data, processing such data (possibly in real-time) and sending the processed data to the home unit for that home. The home unit receives and stores the data collected by the site units and subsequently forwards that collected data to the central facility.

The site unit(s) may be implemented by one or more meters, which may or may not require any physical hardwiring and/or splitters for proper functioning. For instance, as discussed in further detail below, the meter(s) may be non-cabled device(s) that may be installed by a cooperator by merely plugging the meter(s) into electrical wall outlet(s) in proximity to the monitored information presenting device 220. Additionally and/or alternatively, the meter(s) may operatively connect to the home entertainment system 202 to send audio and visual messages to the cooperator. Such messages may instruct the cooperator during setup, configuration, and/or training processes associated with the meter(s) and/or the audience measurement system 200.

The broadcast source 204 of the illustrated example is any broadcast media source, such as a cable television service provider, a satellite television service provider, a radio frequency (RF) television service provider, an Internet streaming video/audio provider, etc. The broadcast source 204 may provide analog and/or digital television signals to the home entertainment system 202, for example, over a coaxial cable or via a wireless connection.

The STB 208 of the illustrated example is any type of set-top box, such as a cable television converter, a direct broadcast satellite (DBS) decoder, a video cassette recorder (VCR), DVD, etc. In some examples, the STB 208 is adapted to receive digital television signals. In these examples, the STB 208 receives a plurality of broadcast channels from the broadcast source 204 (e.g., a plurality of minor channels within the received major channel). The STB 208 selects one of the plurality of received minor channels based on a user input, and outputs one or more signals received via the selected major broadcast channel.

In some examples, the STB 208 is structured to receive analog signals. In the case of an analog signal, the STB 208 tunes to a particular frequency to obtain a program delivered on that channel. For a digital signal, the STB 208 may tune to a frequency channel and then decode certain packets of data contained on that channel to obtain programming delivered on the channel. For example, the STB 208 may tune to a major channel and then extract a program carried on a minor channel within the major channel via the decoding process mentioned above. For some home entertainment systems 202, for example, those in which the broadcast source 204 is a standard RF analog television service provider or a basic analog cable television service provider, the STB 208 may not be present and its function may be performed by a tuner in the television 220.

Prior to a selected household 102, 104, 106, 108 receiving a meter such as a PM, the cooperator's entertainment system may include only those components shown to the left of the dotted line 225. As discussed above, various households may be selected to include a cabled meter that requires some amount of configuration and/or wiring. The cooperator may be deemed competent to handle such installation(s) based on feedback received during the recruitment process, which may reveal a degree of technical savvy that suggests the cooperator is willing and able to perform the configuration. On the other hand, feedback from the cooperator acquired during the recruitment process may identify a lack of technical competence and/or unwillingness to participate in any degree of instrument installation and/or configuration. Such candidates are better suited for a non-cabled meter (as opposed to a cabled meter) that may only require minimal installation and/or configuration procedures before successful operation, as discussed in further detail below.

If the selected household includes a candidate willing and able to do the installation procedures, one or more meter(s) and associated connectivity hardware (e.g., signal splitter) are mailed to that candidate. For instance, in the illustrated example, the cooperator is asked to feed an output from the STB 208 to a signal splitter 216, such as a single analog y-splitter in the case of an RF coaxial connection between the STB 208 and the television 220 or an audio/video splitter in the case of a direct audio/video connection between the STB 208 and the television 220. (For configurations in which the STB 208 is not present, the broadcast source 204 may be coupled directly to the signal splitter 216). In the example home entertainment system 202 of FIG. 2, the signal splitter produces two signals indicative of the output from the STB 208. Of course, persons of ordinary skill in the art will readily appreciate that any number of signals may be produced by the signal splitter 216.

In the illustrated example, the STB 208 is coupled to a back-channel connection 228 to provide a return communication path to the broadcast signal provider corresponding to the broadcast source 204. The STB 208 may use the back-channel connection 228 to send billing and/or status information to the broadcast provider. The back-channel connection 228 may also allow a subscriber to use the STB 208 to request/order content on the information presenting device 220 (e.g., pay-per-view movies, video-on-demand programming, music, etc.), purchase goods and/or services, modify the subscription package associated with the STB 208, etc.

In the illustrated example, one of the two signals from the signal splitter 216 is fed to the information presenting device 220 (e.g., television), and the other signal is delivered to a cabled meter (e.g., the home unit 224 and/or a PM 264). The information presenting device 220 may be implemented by any type of media presenting device. For example, it can be any type of television or television display device. For example, the television 220 may be a television and/or display device that supports the National Television Standards Committee (NTSC) standard, the Phase Alternating Line (PAL) standard, the Système Électronique pour Couleur avec Mémoire (SECAM) standard, a standard developed by the Advanced Television Systems Committee (ATSC), such as high definition television (HDTV), a standard developed by the Digital Video Broadcasting (DVB) Project, or may be a multimedia computer system, etc.

The second of the two signals from the signal splitter 216 is coupled to an input of the cabled meter (e.g., home unit 224 and/or the PM 264). The home unit 224 of the illustrated example is a data logging and processing unit that is used to generate consumption and/or exposure records and/or viewing and/or tuning information useful for determining viewing and/or other metering information. The home unit 224 of the illustrated example collects a set of measurement records (e.g., containing the consumption, exposure, viewing and/or tuning information) and transmits the collected records over a connection 240 via the network 118 to a central office 120 or data processing facility for further processing or analysis. The connection 240 may be a telephone line, a wireless telephone transceiver (e.g., a “cellular” telephone transceiver), a return cable television connection, an RF or satellite connection, an Internet connection or the like.

The home unit 224 of the illustrated example is configured to determine identifying information based on the signal corresponding to the program content being output by the STB 208. For example, the home unit 224 may be configured to decode an embedded ancillary code (e.g., a program identifier added to the broadcast signal expressly for audience measurement purposes and/or a code that is inherently part of the broadcast signal (e.g., a packet identifier (PID)) of a tuned digital program) carried by the signal received via the STB 208. Alternatively or additionally, the home unit 224 may be configured to generate a program signature based on the signal received via connection 236 that corresponds to the program currently being delivered by the STB 208 for display on the television 220. The home unit may then timestamp and add this program identifying information to the measurement records corresponding to the currently displayed program.

To facilitate the determination of program identifying information and the generation of measurement records for the currently presented program content, the home unit 224 may also be provided with one or more sensors 244. For example, one of the sensors 244 may be a microphone placed in the proximity of the information presenting device 220 to receive audio signals corresponding to the program being presented. The home unit 224 may then process the audio signals received from the microphone 244 to decode any embedded ancillary code(s) and/or to generate one or more audio signatures corresponding to a program being displayed.

When the information presenting device 220 has a display (e.g., a television), one of the sensors 244 may be an on-screen display detector for capturing images displayed on the information presenting device 220 and processing regions of interest in the displayed image. The regions of interest may correspond, for example, to an area displaying a broadcast channel associated with the currently displayed program, an area displaying a broadcast time associated with the currently displayed program, an area displaying a viewing time associated with the currently displayed program, etc.

Yet another of the sensors 244 could be a frequency detector to determine, for example, the channel to which the information presenting device 220 is tuned. Persons having ordinary skill in the art will recognize that there are many types of sensors 244 that may be coupled with the home unit 224 (either internal and/or external) to facilitate generation of measurement records containing sufficient information for the central office to determine audience measurement statistics for the monitored households and/or population(s) represented by the monitored households.

The example home entertainment system 202 of FIG. 2 also includes a remote control device 260 to transmit control information that may be received by any or all of the STB 208, the media presenting device 220 and/or the PM 264. Persons having ordinary skill in the art will recognize that the remote control device 260 may transmit this information using any of a variety of techniques, including, but not limited to, infrared (IR) transmission, radio frequency transmission, wired/cabled connection, and the like.

In addition to, or instead of the example home unit 224, the example local metering system 200 may also include the PM 264 to capture information about the audience. The PM 264 of the illustrated example includes a set of input keys/buttons, each assigned to a corresponding member of the household, and may prompt the audience members to indicate that they are present in the audience by pressing the appropriate input key. The PM 264 may also receive information from the home unit 224, if available, to determine a time at which to prompt the audience members. Alternatively, the PM 264 and home unit 224 may be integrated into a single unit. Moreover, the home unit 224 may receive information from the PM 264 to modify an operation of the home unit 224 (such as causing the home unit to generate one or more viewing records based on a change in the viewing audience). As will be appreciated by persons having ordinary skill in the art, the PM 264 may receive and/or transmit information using any type of technique, including, but not limited to, infrared (IR) transmission, radio frequency transmission, wired/cabled connection, and the like. The PM 264 may be implemented by a combination of the remote control device 260 and/or one or more of the STB 208 and/or the home unit 224. In such implementations, the STB 208 and/or the home unit 224 may be configured to display prompting information and/or other appropriate people meter content and/or instructions directly on the information presenting device 220 (e.g., a television). Correspondingly, the remote control device 260 may be configured to accept inputs from the viewing audience and transmit these user inputs to the appropriate device responsible for generating the PM display on the television 220.

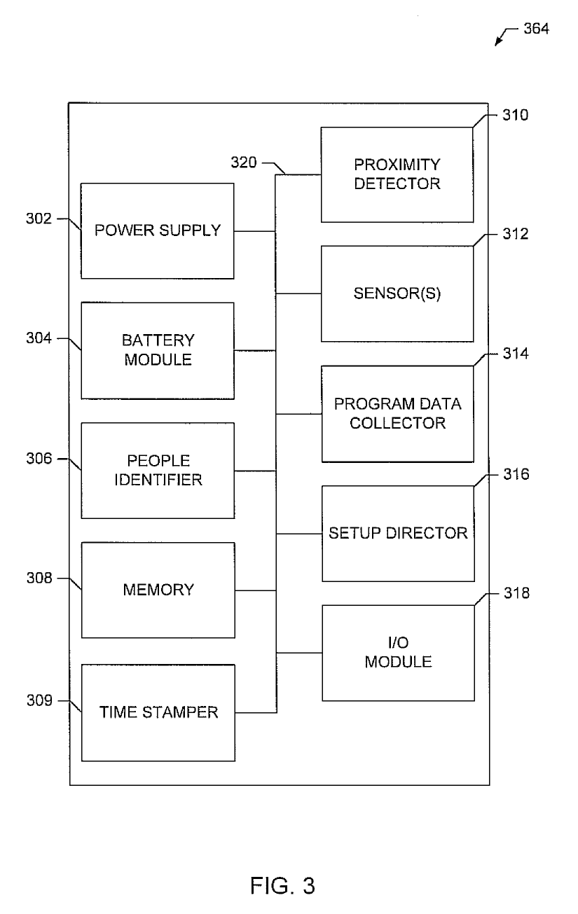

An example meter is shown in FIG. 3. The example meter of FIG. 3 may implement the home unit 224, the people meter 264, and/or other such units. Because, in the example of FIG. 3, the meter includes audience member identification capability, it will be referred to herein as a PM 364. In the illustrated example, the PM 364 includes a power supply 302, a battery module 304, a people identifier 306, a memory 308, a time stamper 309, a proximity detector 310, sensors 312, a program data collector 314, a setup director 316, and an input/output (I/O) module 318. Each of the aforementioned structures is operatively connected to a bus 320 to permit communication therebetween and/or to provide operating power.

In the illustrated example, the PM 364 receives power via the power supply 302 and/or the battery module 304. As discussed in further detail below, the power supply 302 provides power (converting AC power to a suitable DC voltage level) to the PM 364. The power supply 302 also recharges and/or maintains a charge state of one or more batteries in the battery module 304. The battery module 304, which may contain multiple battery cells to meet the voltage and/or current requirements of the PM 364, accommodates the power needs of the example PM 364 when a cooperator's household power supply (e.g., electrical wall outlet) is not available (e.g., power failures in the household that may be caused by adverse weather conditions) and/or immediately after, for example, initial receipt of the PM 364, but before in-home setup and configuration.

The people identifier 306 facilitates the identification of audience members that are exposed to media information from the monitored entertainment center 202 of the example household. Identification of audience members may be performed by the identifier 306 in a passive manner, in which viewers must press a button on the PM 364 and/or a remote control device associated with the PM 364. In such example implementations, each member of the example household is assigned at least one respective identification button on the PM 364. In such examples, the button may include printed indicia having the name of the audience member. Identification of audience members may additionally or alternatively be performed by the identifier 306 in an active manner, in which any technique(s) may by employed to determine the identities of the audience members exposed to media from the entertainment center 202 of the example household. For instance, some active people identifiers 306 employ voice and/or image identification techniques to determine which audience members are exposed to media information from the entertainment center 202. Alternatively, or additionally, the active people identifier 306 may employ RF signaling techniques to determine audience member identity, such as via use of tags that are assigned to each household member and transmit an RF identification signal and/or signature unique to each viewer. The memory 308 of the illustrated example stores data to aid in identifying audience members. For example, the memory may store voice signatures, image signatures, and/or RF identification signals unique to respective member(s) of the household. The time stamper 309 of the illustrated example maintains a current date and time, which may be set by the user, set by an audience measurement company (e.g., set prior to shipment), and/or set via time and date updates provided by the central facility 120 via the network 118. When events occur, such as channel changes and/or PM 364 button presses by an audience member, the time stamper 309 associates the event with the current date and time.

The proximity detector 310 of the illustrated example determines whether the information presenting device 220 is turned on and in near proximity to the PM 364. This determination can be performed in accordance with the techniques described in US Patent Application Publication 2003/0046685, which is hereby incorporated by reference in its entirety. The proximity detector 310 employs an audio detector, such as a microphone, to detect audio signals. As described in US Patent Application Publication 2003/0046685, some televisions employ a transformer that emits audio energy having identifiable frequencies and power levels. Horizontal scan fly-back transformers, for example, may emit a first audio signal at a frequency of 15.75 kHz, and/or second, and/or third audio signals at predetermined spacings from the first audio signal. The memory 308 stores results by the proximity detector 310 indicating when the meter is sufficiently near or in proximity to monitor that device.

The meter 364 of the illustrated example contains one or more sensors for data collection purposes. The example microphone used by the proximity detector 310 is one such example sensor 312. Additionally, or alternatively, the meter 364 may include one or more other audio sensor(s) (e.g., an ultrasonic sensor), and/or optical sensor(s) (e.g., light intensity sensor(s) and/or infrared detectors). The optical sensor(s) may allow the PM 364 to determine if someone has entered or left a room in which the information presenting device 220 is on and/or may allow active identification of persons via face recognition technology. Similarly, audience member presence or absence may be determined with the microphone, which may employ one or more voice signature identification technique(s), as discussed above in view of the example people identifier 306.

The program data collector 314 also employs one or more of the sensor(s) 312 to identify media content being exposed to members of the audience. For example, program or channel identifiers may be collected by extracting embedded watermarks of a broadcast audio signal received by the microphone of the sensor module 312. The watermark embedded in an example broadcast program may include channel identification information, program title information, time of broadcast information, program category type information, and/or other information. As appreciated by persons of ordinary skill in the art, program and/or channel detection may be realized with one or more audio and/or video detection technique(s). For example, channel changing and/or channel identification may be determined by the example program data collector 314 via a video framegrabber and an on screen display reader (OSDR) trained to monitor predetermined regions of interest (ROIs) of a television screen. In some examples, a channel change results in the channel identification information being displayed on a particular ROI of a display screen, which may be monitored by the OSDR. The OSDR may initially detect screen blanking that typically precedes a channel change. The screen blanking may arm the OSDR so that when the OSDR detects an image in the ROI typically associated with a channel change, the image extracted from the ROI is interpreted as channel information. Associating the extracted channel image data only after a screen blanking occurrence reduces erroneous channel-change events in case a commercial and/or other program happens to display numeric images in the ROI typically associated with channel information.

The setup director 316 of the example PM 364 allows one or more audience members of a selected household to receive setup, configuration, and/or training instructions for the PM 364 via audio and/or video signals. Prior to shipping the PM 364 to a cooperator, such as a household member capable and willing to perform setup procedures without the aid of a field representative, the setup director 316 of the illustrated example is configured for a particular target household. For example, the setup director 316 may be configured to employ a predetermined subset of audio prompts saved in the memory 308, such as voice prompts having a particular language, dialect, accent, and/or etiquette style. The setup director 316 may, additionally or alternatively, permit various voice and/or video prompts to be customized for the destination household, such as including personalized instructions containing the household member's name and/or other messages unique to the destination household. Personalized messages may recite a greeting and/or household member name prior to reciting an instructional message. For example, a personalized message may recite, “Good morning Mrs. Kowalski. Please press your identification button if you are in the room.”

After the PM 364 is customized for a particular household, as discussed in further detail below, the setup director 316 is configured to place the example meter 364 into a shipping mode. Generally speaking, the shipping mode arms the PM 364 so that when the meter 364 is received (e.g., via mail or other courier) by an audience member of the target household, a welcome message is played to the audience member to congratulate him/her for participating in the market study. For example, the shipping mode, similar to a sleep mode in which no data is acquired and no audience member prompts are requested, may cause one or more LEDs to blink at a low frequency, thereby consuming very little power from the battery module 304. The user that opens the packaging material upon receipt of the meter 364 may press one or more of the buttons on the meter 364 to stop the shipping mode and invoke a setup mode. The welcome message may describe to the user how much time the setup, configuration, and training may take so that the household member(s) may plan accordingly.

Instructions, messages, and/or meter operator training information may be communicated to the audience members via audio signals emitted by speakers built-in to the example PM 364. Such speakers may be part of the I/O module 318 and/or operatively attached to the PM 364 in any manner known by persons of ordinary skill in the art. The I/O module 318 may also include one or more buttons, some or all of which are respectively assigned to a household member. Each button may include a corresponding LED that illuminates and/or flashes to indicate a request for input and/or acknowledgement. Names of each household member may also be displayed proximate each button on, for example, adhesive indicia.

The I/O module of the illustrated example also includes audio and/or video port connectors that permit audio and/or video signals to be transferred to the audience member's entertainment system 202. Video port connectors may include, but are not limited to RCA jacks, S-Video plugs, digital visual interface (DVI) ports, and/or high definition multimedia interface (HDMI) ports. The setup director 316 of the illustrated example causes the PM 364 to exit the shipping mode upon a household member pressing any button of the I/O module 318. Upon exiting the shipping mode, the setup director 316 retrieves and plays a welcome message and/or audio instructions to the user regarding setup procedures. Such audio instructions may initially request that the household member connect the PM 364 to the information presenting device 220, such as by way of the example splitter 216 and the aforementioned A/V ports. When the household member completes an initial setup by connecting audio and/or video output from the I/O module 318 to the splitter 216, then remaining messages, instructions, and/or training procedures may be communicated to the household member(s) via the audio and/or video of the home entertainment center 202. Video messages, for example, may be transmitted by the I/O module 318 as an overlay image to a television 220, thereby allowing the audience members relatively unobstructed viewing of any displayed program while allowing visual messages to be displayed. Such messages may include simple text, such as “Dear Mrs. Jackowski, please press your identification button if you are in the room.” Messages may also include, without limitation, various icons, pictures, and/or text messages displayed in any location of the information presenting device 220.

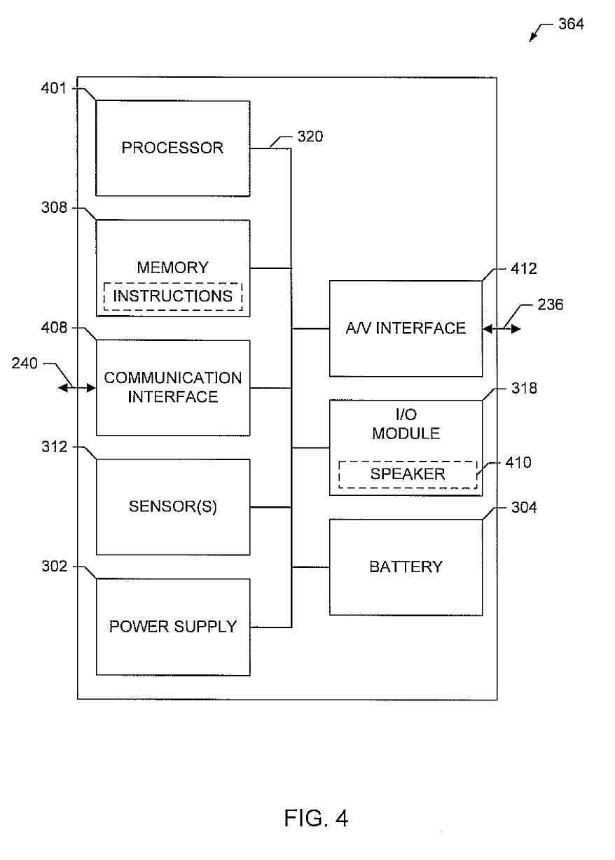

FIG. 4 is a block diagram of an example manner of implementing the PM 364 of FIG. 3. Like structure in FIGS. 3 and 4 are numbered with like reference numerals. The example PM 364 of FIG. 4 includes a processor 401 that may be operatively connected to the other components of the PM via a bus 320. The processor 401 can be part of a computer, for example, a personal computer, a personal digital assistant (PDA), an Internet appliance, or any other type of computing device. The processor 401 can be implemented by one or more Intel® microprocessors from the Pentium® family, the Itanium® family or the XScale® family. Of course, other processors from other families are also appropriate. One or more processors such as processor 401 may be used to implement the PM 364.

The processor 401 is in communication with a main memory 308, which may include a volatile memory and a non-volatile memory, via the bus 320. The volatile memory may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory may be implemented by flash memory and/or any other desired type of memory device. Access to the main memory 308 may be controlled by a memory controller (not shown) in a conventional manner.

The memory may also include mass storage devices and/or access to mass storage devices through an interface, such as a communication interface 408 and network. Examples of such mass storage devices include floppy disk drives, hard drive disks, compact disk (CD) drives and DVD drives. The mass storage device(s) and/or the volatile memory may be used to store viewing records in the meter 364.

The memory 308 stores machine readable instructions for execution by the processor 401. It may also store collected audience measurement data and/or prompting data for the viewer, as discussed in further detail below. A communication interface 408 is also operatively connected to the processor 401 via the bus 320 to permit communication capabilities between the PM 364 and the network connection 240. The communication interface 408 may be implemented by any type of interface standard, such as an Ethernet interface, a universal serial bus (USB), and/or a third generation input/output (3GIO) interface. The communication interface may also include a modem or network interface card to facilitate exchange of data with external computers and/or other devices via a network (e.g., an Ethernet connection, a digital subscriber line (DSL), a telephone line, coaxial cable, a cellular telephone system, etc.), such as the example network 118 of FIGS. 1 and/or 2. The communication interface 408 may send collected data back to a central facility 120 via a telephone line connection, an Internet connection, a network, an RF connection via an RF transceiver, and/or a wireless telephone connection via a wireless telephone transceiver (e.g., a “cellular telephone” transceiver). Additionally, the communication interface 408 allows update information to be transferred from the central facility 120 to the PM 364. Update information may include, for example, new household audience member biographical information, new visual prompting instructions (e.g., text, graphics), time and date updates, and/or new audio prompting instructions. Audio based prompting instructions may be retrieved from the memory 308 by the PM 364 and output to one or more speakers 410 which, as shown in the example of FIG. 4, may be built-in to the PM 364. Audio and/or video based prompting instructions, such as configuration tutorials, may be retrieved from the memory 308 and output to an A/V interface 412, which may further be connected to the cooperator's entertainment system 202 via the splitter 216. Audio, video, and other data may propagate in a bidirectional manner along the connection 236 between the splitter 216 and the PM 364.

If the cooperator has a cabled meter connected to the entertainment system 202, then the meter may take advantage of the cooperator's information presenting device 220 to communicate instructions via video and/or audio. On the other hand, if the selected household 102, 104, 106, 108 received a non-cabled meter (e.g., a stand-alone unit to be connected only to an electrical wall outlet for power), then audio based instructions may be output to the meter's speaker(s) 410 to assist the cooperator during installation, configuration, and/or training. When the meter 364 is provided with a display as in some alternative examples discussed below, visual instructions are also displayed. Some example PMs 364 include a set of light emitting diodes (LEDs) to communicate to the audience member that actions must be taken. For example, a solid color LED may communicate to the audience member that no actions are necessary at this time, while a blinking LED may communicate to the audience member that he/she should press an identification button of the PM 364 to verify media consumption by a particular household member and/or the presence of a particular member in the audience. Other example meters 364 include more sophisticated communication elements, such as liquid crystal display (LCD) units capable of displaying text and/or video information to the cooperator. These various I/O elements, such as LEDs, button keypads having each member's name or other identifier printed thereon, and/or LCD units may be driven by an I/O module 318, as will be appreciated by persons of ordinary skill in the art. Input devices controlled and/or driven by the I/O module 318 may permit a user to enter data and/or commands into the processor 401. The input devices can be implemented by, for example, a keyboard, a mouse, a touchscreen, a track-pad, a trackball, an isopoint and/or a voice recognition system.

One or more output devices may also be connected to the I/O module 318. Such output devices can be implemented, for example, by display devices (e.g., a liquid crystal display, a cathode ray tube display (CRT)), one or more LEDs, LED arrays, by a printer and/or by speakers. The I/O module 318 includes a graphics driver card for driving a display.

The example PM 364 may determine whether a television is operating in a household by using one or more sensors 312. For example, audio output from a information presenting device 220 (e.g., television speakers, stereo speakers, surround-sound speakers connected to the television, etc.) is received by the PM 364 via a microphone 312. Any number of various sensing devices that convert mechanical, electrical, and/or optical stimulation into a meaningful signal may be included in the meter 364. For example, any or all of microphone(s), ultrasonic detector(s), light detector(s) (e.g., infrared detector(s)), motion sensor(s), and/or RF sensor(s) may be included. The audio signals received by the microphone are analyzed by the processor 401 to determine whether the audio is background noise unrelated to the monitored information presenting device (e.g., people talking, street sounds if windows are open, etc.), or the audio is originating from a broadcast program. When the information presenting device is not turned on, the example PM 364 may enter a “sleep” mode, in which no data is acquired and no audience member prompts are issued by the PM 364 (e.g., a blinking LED requesting that the audience member press their assigned identification button, voice prompts, etc.).

Audio emitted by the information presenting device (received from any type of broadcast source 204) may include an embedded watermark signal (e.g., a code, program identifier, etc.) that is not perceptible to human ears. The sensor(s) 312 (e.g., a microphone(s)) pick-up these watermark(s), if present, and the processor 401 extracts the watermark(s) to determine an identity of the program being aired.

In the illustrated example, a power supply 302 and/or a battery provides power to the example PM 364, depending on whether the PM 364 is connected to an electrical outlet, such as a standard 110 volt or 220 volt alternating current (AC) outlet (“wall outlet”) found in most residential households. If the PM 364 is connected to the wall outlet, then the power supply 302 provides power to the PM 364 and recharges and/or maintains a charge state of the battery. If the PM 364 is not connected to the wall outlet, or if a power failure occurs, then the battery provides power to enable the PM 364 to monitor audience activity. For example, if a power failure occurs due to a thunderstorm, then the PM 364 may continue to operate and determine whether or not the audience members are listening to a radio (AM, FM, satellite radio). Radio broadcast transmissions may also contain embedded watermarks which are inaudible to humans, but detectable by the PM 364 for program identification.

Battery power is particularly helpful for enabling the media device to communicate installation and/or configuration instructions to the cooperator when the meter 364, first arrives at the household. As discussed in further detail below, after the cooperator receives the PM 364 in the mail (or via courier, etc.), the battery in the PM 364 allows the processor 401 and other on-board components to operate. For example, the speaker 410 may be powered to announce one or more installation instruction(s). Upon the cooperator's receipt of the PM 364, the cooperator may press a “start” button (or any of the buttons assigned to an audience member) on the PM 364 to hear a welcome message. The PM 364 of the illustrated example is preprogrammed with the recipient's name and other demographic details so that the welcome message, for example, may state, “Dear Mr. Smith, thank you for agreeing to participate in our market study program. Please place this meter on top of your television.” The battery may include a sufficient amount of power to prompt the cooperator through a series of configuration instructions, including, for example, an instruction that requests the cooperator plug the PM 364 into a wall outlet to connect the meter to commercial power.

Additional voice instructions may be emitted by the speaker 410 of the example PM 364 to guide the cooperator through the setup procedures. One or more voice prompt(s) stored in the memory 308 may include detailed operational instructions. The instructions may supplement, or be supplemented by written documentation, such as a pictorial leaflet, brochure, and/or instruction booklet. In such examples the cooperator may use the booklet while listening to the audio instructions to make proper connections between the PM 364 and the cooperator's home entertainment system 202. As discussed before, some meters do not require any hardwire connections (non-cabled meters), thereby involving less cooperator labor.

On the other hand, some example meters employ connectivity to the cooperator's home entertainment center (“cabled” meters), such as video and/or audio connectivity to the information presenting devices 220. Example PMs that connect to a cooperator's information presenting device, either directly or via the splitter 216, allow visual and/or audio prompting techniques to occur in a “user friendly” manner. For example, while a non-cabled meter may employ an on-board speaker 410, blinking LEDs, and/or an LCD screen to prompt audience members to take action, a PM connected to a television may display visual prompts (e.g., text and/or images) through the television and/or use speakers of the entertainment system 202 to request audience members to take action(s). Setup and configuration instructions for households that have cabled meters may begin initially with audio based setup instructions that direct the cooperator to first connect the meter to the video input of their home entertainment system 202. Upon completion of preliminary setup and connectivity to the cooperator's television video input, subsequent instructions regarding setup and training may be communicated to the cooperator in both a visual and audio format.

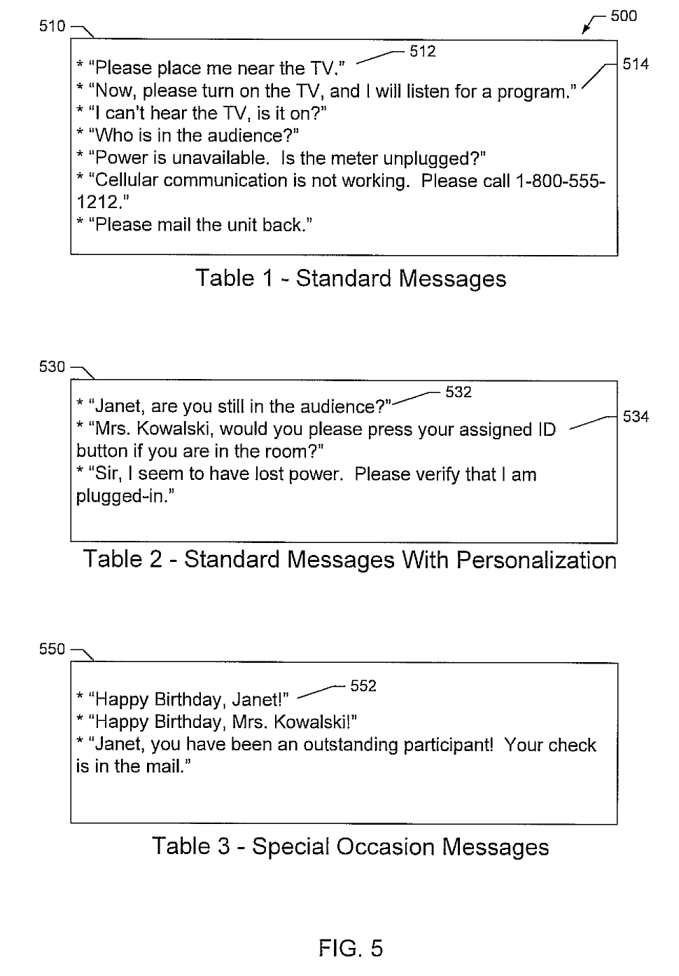

FIG. 5 illustrates example audio and/or text messages (hereinafter “messages”) that may be stored and presented to audience members of the example household. Some of the messages may be standard messages, as shown in Table 1 (510), which are recited and/or displayed to each audience member in the same manner irrespective of the member's identity (i.e., regardless of the age, sex, or geographic region of the audience member). For example, during a setup process, a standard message may recite “Please place me near the television,” 512 and “Now, please turn on the television and I will listen for a program” 514. Other messages may include customization unique to the audience member(s) in the household, as shown in Table 2 (530). By adding the audience member's name to the announced and/or displayed message, the audience member may feel more at ease with the meter. For example, a message may recite “Janet, are you still in the audience?” 532 or “Mrs. Kowlaski, would you please press your assigned identification button if you are in the room?” 534. Special occasion messages may also be stored and presented to audience members, as shown in Table 3 (550). Such special occasion messages may include, but are not limited to birthday greetings, anniversary greetings, and messages thanking the audience member(s) for a particularly good job of complying with metering procedures. For example, a message may recite “Happy birthday Janet!” 552. Messages stored and presented to audience members may also incorporate one or more types of etiquette present in certain geographic regions. For example, while people in the Northern regions of the United States typically refer to each other by their first names, many people in Southern regions incorporate formalities such as “Maam,” and “Sir.”

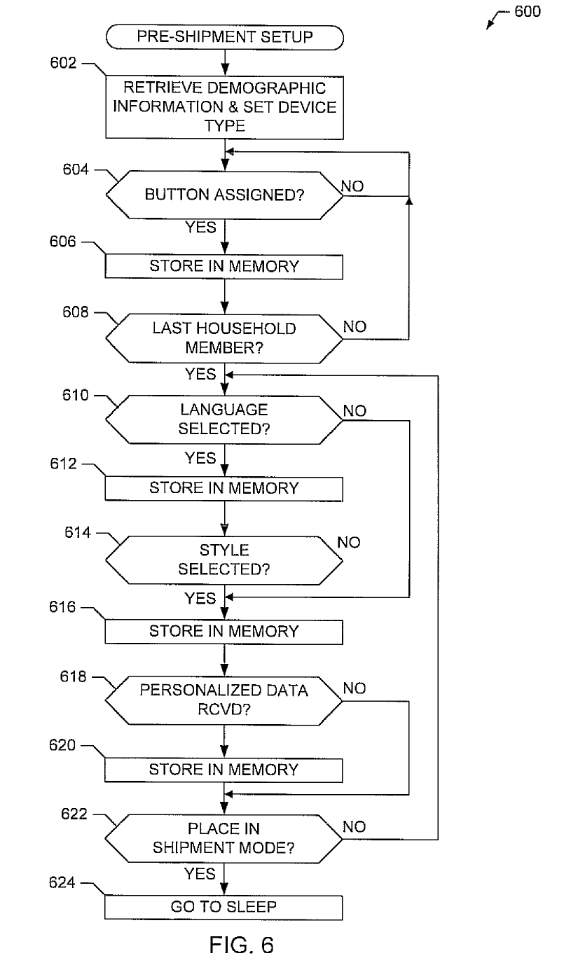

The example meter(s) of FIGS. 2-4 are configured for a specific household prior to shipment. Customization of messages to accommodate for audience member languages, names, ages, special occasions, and/or formalities related to etiquette (which may or may not be geographically and/or culturally specific) may improve audience member compliance. A flowchart representative of example machine readable instructions for implementing an example pre-shipment setup 600 is shown in FIG. 6. In this example, the machine readable instructions comprise a program for execution by: (a) a processor such as the processor 401 shown in FIG. 4, which may be part of a computer, (b) a controller, and/or (c) any other suitable processing device. The program may be embodied in software stored on a tangible medium such as, for example, a flash memory, a CD-ROM, a floppy disk, a hard drive, a digital versatile disk (DVD), or a memory associated with the processor 401, but persons of ordinary skill in the art will readily appreciate that the entire program and/or parts thereof could alternatively be executed by a device other than the processor 401 and/or embodied in firmware or dedicated hardware in a well known manner. For example, any or all of the meter 364, the people identifier 306, the time stamper 309, the proximity detector 310, the program data collector 314, and/or the setup director 316 could be implemented by software, hardware, and/or firmware (e.g., it may be implemented by an application specific integrated circuit (ASIC), a programmable logic device (PLD), a field programmable logic device (FPLD), discrete logic, etc.). Also, some or all of the machine readable instructions represented by the flowchart of FIG. 6 may be implemented manually. Further, although the example program is described with reference to the flowchart illustrated in FIG. 6, persons of ordinary skill in the art will readily appreciate that many other methods of implementing the example machine readable instructions may alternatively be used. For example, the order of execution of the blocks may be changed, and/or some of the blocks described may be changed, substituted, eliminated, or combined.

The process 600 of FIG. 6 begins at block 602 where the PM (264 and/or 364) retrieves demographic information regarding the target household, and sets a bit designating the meter as either cabled or non-cabled, discussed in further detail below. Data retrieval and receipt may be initiated by, for example, a technician that enters a unique sequence of button presses on the PM 364. Additionally, or alternatively, the technician may invoke a pre-shipment configuration mode by accessing and modifying circuit board jumpers, internal dip switches, and/or providing authorization access codes to the PM 364 via a computer connected to the example PM 364 via, for example, a serial cable, USB cable, and/or any other wired or wireless communication medium. Demographic information may be stored in a memory, such as the memory 308 discussed above in view of FIGS. 3 and 4. Demographic information may include, but is not limited to geographic information, audience member names, ages, gender, and viewing preferences. Each member of a target household is assigned at least one button (block 604), such as a button of the I/O modules 318 of FIGS. 3 and 4. The buttons may include a label or other indicia to identify which button corresponds to which audience member of the selected household. Button assignments (block 604) may be stored in the memory 308 (block 606). The PM 264, while in a pre-shipment configuration mode, waits in a loop for button assignment instructions (block 604), stores button assignments in memory when received (block 606), determines whether additional button assignments are to be configured (block 608), and repeats in the event that additional audience members require a button assignment.

Upon completion of assigning each audience member at least one button (block 608), the PM 364 determines whether a prompting language has been selected (block 610). Language selection may occur by virtue of demographic data retrieved (block 602) and stored in the memory, or may be selected by the technician during pre-shipment configuration and stored in the memory (block 612). Similarly, an etiquette style (e.g., formal, informal, etc.), dialect, and/or accent may be selected (block 614) and stored to memory (block 616), or such settings be automatically made by virtue of demographic data received earlier (block 602). Personalized data may be received (block 618), such as audience member birthday information, age information, wedding anniversary information, and/or any other type of information that may further personalize interaction between the example PM 364 and the audience members. Such personalized information is stored in memory (block 620) before determining whether to place the PM 364 in a shipment mode (block 622). Control may return to block 610 to allow changes to the information entered at blocks 610, 614, and/or 618.

After the PM 264, 364 is placed in shipment mode (block 622), the meter goes to sleep (block 624). The meter can then be shipped to the target household. Battery consumption of the PM 364 is conserved during the shipment mode so that sufficient power remains within the battery module 304 to play a welcome message and installation instructions to the audience member prior to the audience member having an opportunity to plug the PM 364 into an electrical outlet, as discussed in further detail below.

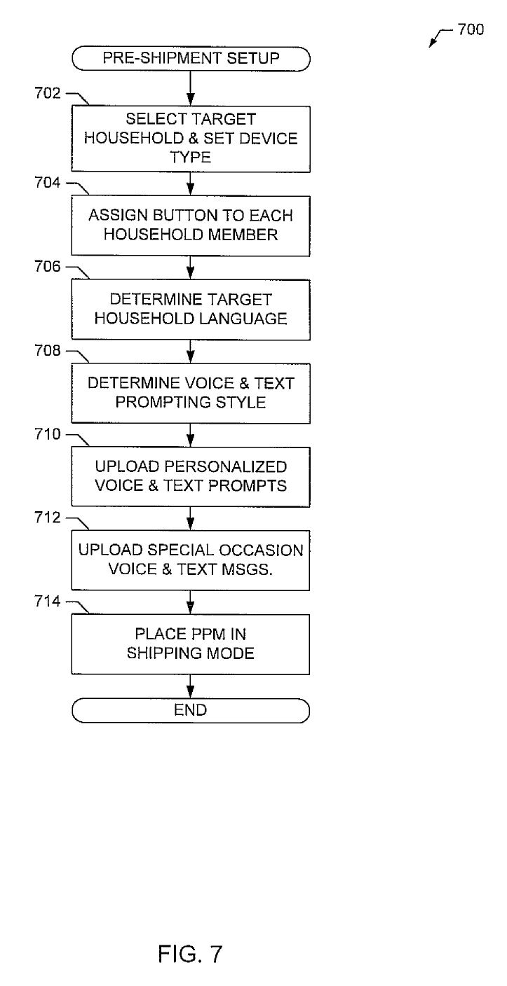

Another flowchart representative of an example pre-shipment setup 700 is shown in FIG. 7. The process of FIG. 7 begins at block 702 where a household (which may have been contacted via a random telephone call or letter) is selected to participate in a media data gathering process, and the meter is set as either cabled or non-cabled. To determine if a household should be selected, a brief telephone interview may be held to determine whether a household, and/or other members of that household, are interested in participation and fit a desired demographic profile. If a person/household expresses a willingness to participate, the interview may collect additional detailed information related to all the household members, their ages, genders, hobbies, interests, and/or questions to determine technical competence/comfort. Depending on the capabilities and/or willingness of the audience member(s) to perform relatively simple electrical connections, the household may receive a cabled meter that presents audio/video (A/V) signals via the homeowner's entertainment center, or a non-cabled meter that does not present A/V signals via the homeowner's entertainment center. For example, some candidate households may fit a demographic class of interest, but be unwilling to perform even an insignificant amount of A/V wiring with a meter. In such a case, the household may receive a non-cabled meter whose setup may only involve connection to a wall outlet for power.

Each member of the selected household is assigned at least one button of the example PM (264 and/or 364) of FIGS. 2-4 (block 704). Household member button assignments of buttons on the PM 264 and/or a remote control for the example PM 264 facilitate identification of a viewer in the room when television programs are being displayed. The pre-shipment setup process 700 also includes determining a language of preference for the selected household (block 706). In particular, the example PM 264 may be employed in any country, and/or within a single country having various different languages. For example, the example PM 264 may be configured to recite and display messages in English for predominantly English-speaking neighborhoods, recite and display messages in Spanish for predominantly Hispanic neighborhoods, recite and display messages in Polish for predominantly Polish neighborhoods, and/or recite and display Hindi messages for neighborhoods and/or households with large concentrations of Indian people. Each of the messages in the example Table 1 (510) of FIG. 5 may be replaced with similar standard messages 510 that are particular to any language.

Language and message flexibility is further enhanced by accommodating particular formalities and/or etiquette information. As discussed above, any of the standard messages 510, 530, and custom messages 550 may be configured to adhere to local expectations of etiquette, such as the use of “Sir” and/or “Maam.” An appropriate etiquette selection may be determined based on the telephone interview with candidate households, household member age categories, and/or regional destinations (block 708). Without limitation, the messages recited to the household members may include various accents and/or dialects found in any particular geographic region of the country. Standard messages with various customization based on audience member names, such as the example messages of Table 2 (530), may be uploaded to the example PM 264 memory 308 (block 710). Similarly, messages indicative of special occasions unique to the household members may be uploaded to the memory 308 (block 512) of the example PM 264, which include, but are not limited to, birthday wishes, anniversary congratulations, and messages thanking the audience members for a job well done regarding compliance with metering rules.

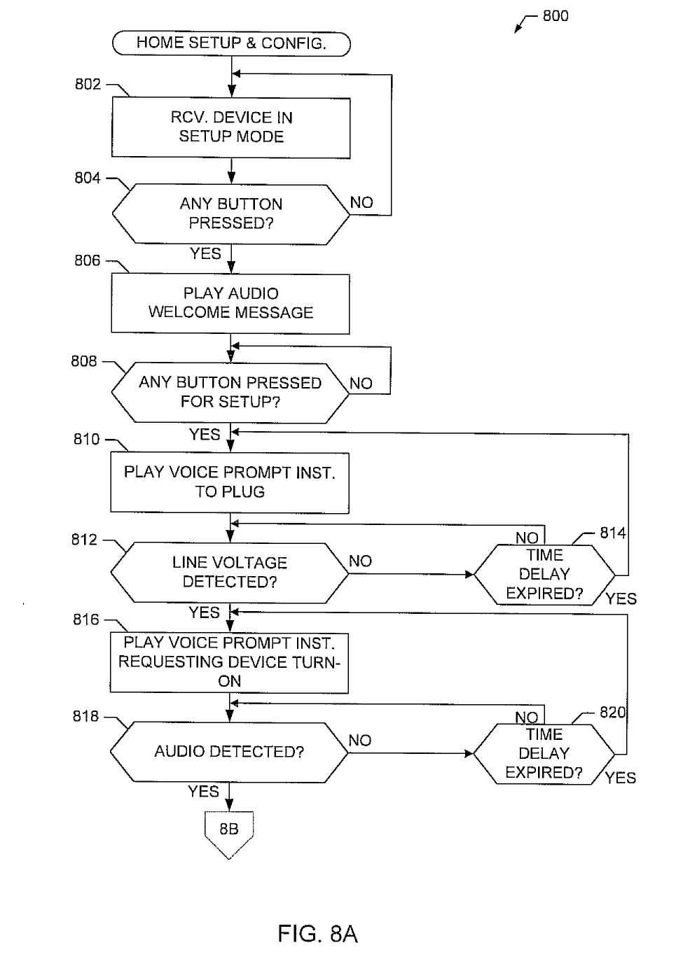

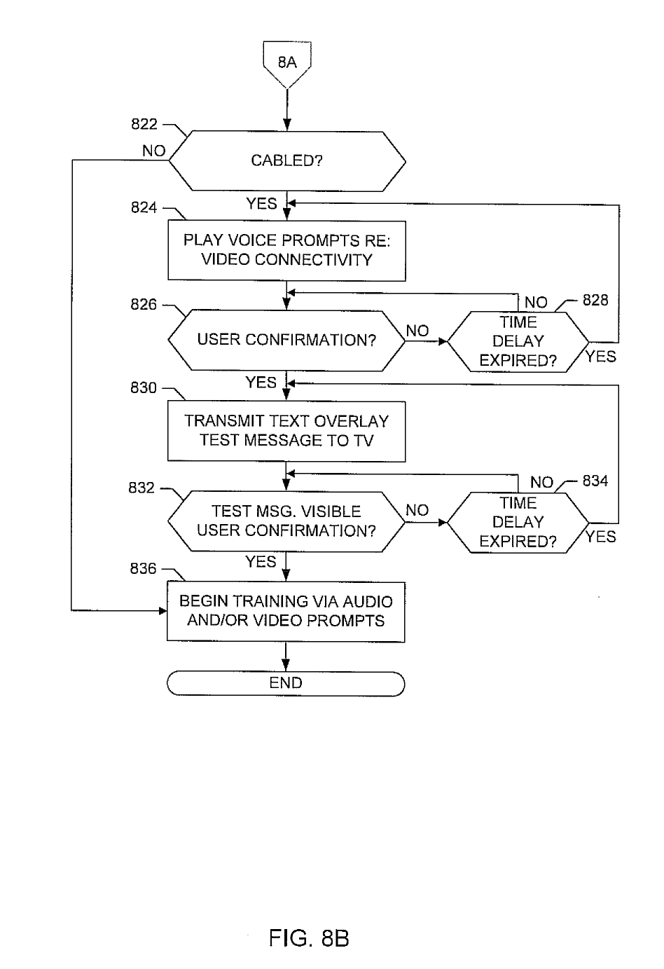

Prior to shipping the configured PM 264, 364 to the selected household, the PM 264, 364 of the illustrated example is placed into a shipping mode (block 714). The example PM 364 of FIG. 4, including the processor 401 and other components, consumes very little electrical power from the battery during the shipping mode. As such, sufficient power to operate the PM 364 for a length of time (e.g., 1 hour) should remain in the battery when the example PM 364 arrives at the selected household. In the illustrated example, one or more LEDs on the PM 364 blinks at a very low frequency to alert the receiving audience members that the PM 364 is ready to be setup and configured for operation in the household. The example PM 264, 364 of FIGS. 3 and 4 may be shipped along with a user manual or pamphlet having graphical instructions on how to configure the PM 264. However, because the PM 264 of the illustrated example also includes audio and/or text based messages, the user manual and/or pamphlet does not need to be long or detailed and may even be omitted. Reducing the size and complexity of a user manual may be helpful in reducing audience member anxiety and/or intimidation during the setup and configuration process of the PM 264. Upon receipt of the PM 264 by the audience member, the pamphlet and/or user manual may simply indicate that the audience member should press the button nearest the blinking LED to begin the setup process. When the audience member presses the button nearest the blinking LED, the shipping mode ends and a home setup and configuration process 800 begins, as discussed in further detail below with reference to FIGS. 8A and 8B.

Referring to FIG. 8A, the audience member receives the PM 264, 364 (block 802) by mail or any other carrier service, such as FedEx®, UPS®, DHL®, etc. As described above, the PM 264 of the illustrated example is shipped in a shipping mode wherein at least one LED periodically blinks at a low frequency. Persons of ordinary skill in the art will appreciate that processors and/or systems designed with processors may be configured to operate in a power-saving mode, and that LEDs are particularly well-suited indicators for such modes due to their low power consumption rates. Absent any button presses of the example PM 264 (block 804), then the PM 264 continues to operate in the shipping mode. However, when a household member receives the example PM 264, removes the PM 264 from the shipping container, and presses a button of the PM 264 (block 804), then the shipping mode ends and the audience member is presented with an introduction message (block 806). As discussed above, audio and text messages saved in the memory 308 may be presented to the audience members via speakers 410 built-in to the example PM 264 and/or via the audience member's television when connected thereto. Persons of ordinary skill in the art will appreciate that numerous audio file formats may be saved in the memory 308 and played at any time. Audio file formats may include, but are not limited to, audio video interleave (AVI), WAVE (WAV) format by Microsoft®, audio interchange file format (AIFF), Windows® media audio (WMA), and MPEG audio layer-3 (MP3). The welcome message may inform the audience member that the setup and configuration process may take a certain number of minutes to complete, thereby allowing the audience member an opportunity to postpone the setup and configuration process for a more convenient time (e.g., by pushing a button on the PM 264, 364 indicating a desire to delay). The welcome message may also request that all members of the household be present so that any configuration, such as audience member voice recognition/identification, may be completed at one time. In addition to receiving the PM 264, 364 in the shipment, the user may also receive one or more accessor(ies) to use during the installation, such as a user manual, an installation brochure with illustrations, an A/V splitter 216, and/or one or more A/V cable(s) to interconnect the audience member's entertainment center 202 with the PM 264.

When the audience member presses a button on the PM 264, 364, such as a button proximate to a blinking LED, to indicate a willingness to commence the home setup and configuration process (block 808) as described to the audience member during the welcome message, a voice message instructs the audience member to plug the PM 264 into a wall outlet near the television 220 (block 810). The PM 264 of the illustrated example then attempts to detect any voltage (block 812). If line voltage is not detected by the PM 264 (block 812), then the PM 264 initiates a time delay (block 814). Persons of ordinary skill in the art will appreciate that the processor, such as the processor 401 of FIG. 4, may detect when the power supply 302 is receiving alternating current (A/C) and/or when the battery is receiving a charging current, each of which indicates that the PM 264, 364 is plugged into an electrical outlet. If the time delay (block 814) expires, then the PM 264 plays the voice message instruction to plug the PM 264 into an electrical outlet (block 810).

When line voltage is detected (block 812), the PM 264, 364 of the illustrated example plays an audio message via the built-in speakers 410 requesting that the audience member turn-on their information presenting device 220 (block 816). The PM 264 then attempts to detect an audio signal. If the PM 264 does not detect audio via one of the sensors 312 (e.g., a microphone) (block 818), then the PM 264 initiates a timer (block 820). If the time expires (e.g., reaches a predetermined value) without an active signal being detected, the request to turn-on the television is repeated (block 816). Detecting audio indicates that the example PM 264 has been placed in appropriate proximity to the information presenting device 220 for proper operation. If several iterations of blocks 816 through 820 repeat without successfully detecting audio, the PM 264 may invoke alternate voice messages to be played to the user reciting alternate instructions. For example, the alternate voice message may recite, “Please turn the volume up slightly,” or “Dear Mrs. Kowalski, please select a different channel and we'll try listening again.”

When audio is detected (block 818) from the information presenting device 220, the PM 264, 364 of the illustrated example determines whether the household will employ the PM 264 in a cabled or non-cabled manner (block 822), as shown in FIG. 8B. The PM 264 may accomplish this determination by accessing a memory location in the memory 308 in which a variable is set to indicate one of two modes (e.g., a bit is set to “0” for cabled mode or to “1” for non-cabled mode). The memory location/variable is typically set during the pre-shipment setup process 602, 702. Persons of ordinary skill in the art will appreciate that other methods of setting a mode of the PM 264 are possible, such as setting circuit board jumpers or setting a dip-switch within the example PM 264. If the example PM 264 will employ the A/V outputs of the audience member's entertainment center (block 822), then the PM 264 of the illustrated example will employ visual text prompting via various messages, such as the messages of Table 1 (510), Table 2 (530), and/or Table 3 (550) shown in FIG. 5. To enable this functionality, the audience member is presented with a series of voice messages that facilitate connecting the PM 264 with the entertainment center and/or information presenting device. In the illustrated example, instructions recited to the audience member clearly describe tools needed (if any), interconnecting components, such as the splitter 216 and/or A/V cables, and explain how to connect components together (block 824).

As discussed above, the audience member may have also received a user manual and/or a pictorial brochure that describes typical A/V cables, pictures of connecting ports (e.g., RCA jacks, S-Video plugs, digital visual interface (DVI), high definition multimedia interface (HDMI), etc.), pictures of the A/V equipment, and/or pictures of where the A/V equipment receives such cable terminations. It will be appreciated that any needed cables will preferably be shipped with the PM 264, 364. The PM 264 of the illustrated example waits to obtain a response from the user that the video connection has been established (block 826). If the audience member does not confirm that the video connection process is complete (block 826), a timer is initiated by the PM 264 (block 828) while waiting for the audience member to perform all, or some of connections to complete the PM 264 with the entertainment center 202 (block 824). Expiration of the timer (block 828) results in some or all of the instructions being repeated (block 824). When the audience member has completed setup procedures that connect the PM 264 to the television 220 (either directly or via the splitter 216) (block 826), the PM 264 of the illustrated example transmits a sample video image to the television 220 (block 630). The sample video image may include, for example, a picture, some sample text, and/or an icon that overlays any video content transmitted by a broadcast television, satellite, or cable station. If the audience member does not confirm that the sample video image is seen (block 832), then the PM 264 invokes a timer (block 834) to give the audience member ample time to look at the television 220 and verify whether the sample video image is present or not. If the audience member confirms that the sample video image was successfully seen on the television 220 by, for example, pressing a button on the meter (block 832), then the home setup process is complete and the process of configuring and training begins (block 836).

Returning to block 822, if the selected household received a non-cabled PM (block 822), then the video setup blocks (e.g., blocks 824-834) are skipped and the configuration and training process begins (block 836).

The training process may include any number of exercises designed to test the PM 264 and/or to teach the audience members how to operate the PM 264. For example, the PM 264 of the illustrated example requests that one or more of the audience members leave the room and return 30 seconds later to test a motion sensor built-in to the sensors module 312 of the PM 264. Any failure of the PM 264 motion sensor to detect a person entering the room may indicate that objects are blocking the PM 264, and/or that the PM 264 should be placed in an alternate location. Additionally, the configuration process (block 836) may include a request that each audience member separately recite one or more paragraphs from the user manual to train the PM 264 to recognize each audience member's voice.

After setup, configuration, and user training is complete, during normal operation, the PM 264 of the illustrated example receives and transmits data from/to the central facility 120 via the network 118. Transmitted data may include data logs of audience members and the associated programs viewed by them. As described above, the viewed programs may be identified via program signatures and/or watermarks embedded within program audio that are detected by the sensor module 312 (e.g., a microphone) of the PM 264 and extracted for identification purposes by the PM 264 or at a central facility in communication with the PM 264. Transmitted data may also include information identifying whether household guests may have been viewing, such as a babysitter or a dinner guest. Data received by the PM 264 from the central facility 120 may include, but is not limited to, compliance messages, new or alternate specialized messages, and firmware/software updates for the PM 264.

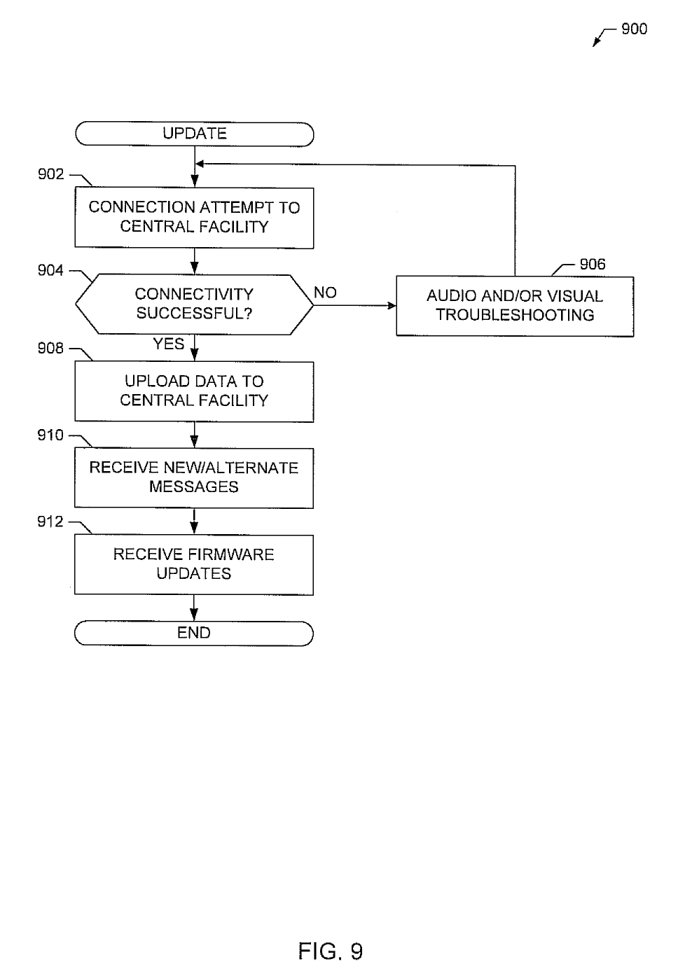

FIG. 9 is an example flowchart to illustrate communication between the PM 264, 364 and the central facility 120. The example process 900 begins with the communication interface 240 of the PM 264 establishing a connection to the central facility 120 (block 902). The processor, such as the processor 401 of the PM 364, may invoke connectivity attempts (block 902) at any desired time (e.g., on a periodic (e.g., daily, weekly) basis, when a connectivity attempt when the memory 308 reaches a certain threshold capacity of acquired data, etc.). If the connectivity attempt is not successful (block 904), then the PM 264, 364 may display a visual text overlay message on the audience member's television 220, invoke an audio message via the built-in speakers 410, and/or illuminate an error LED on the PM 264 (block 906). The message may include various suggestions to the audience member intended to remedy the communication failure, such as a message “The phone cable is not plugged in, please plug me in.”

If the connectivity attempt (block 902) is successful (block 904), then the PM 264 uploads audience member data to the central office 120 (block 908). Additionally, alternate standard messages 510, custom messages 530, and/or special occasion messages 550 may be received by the central office 120 during the connection (block 910). As discussed above, special messages may include congratulatory messages that express an appreciation that the audience member(s) have been particularly compliant with measurement instructions. For example, a special message may recite, “You've been an outstanding participant this month! Your bonus check is in the mail!” Additionally, if the PM 264 requires any firmware updates, they may be received during the connection between the central office 120 and the PM 264 (block 912).

Although certain methods, apparatus and articles of manufacture have been described herein, the scope of coverage of this patent is not limited thereto. On the contrary, this patent covers all apparatus, methods and articles of manufacture fairly falling within the scope of the appended claims either literally or under the doctrine of equivalents.

1. A method to configure an audience meter comprising:
receiving audience information;
configuring the audience meter based on the audience information;
placing the audience meter in a sleep mode; and
shipping the audience meter to a location associated with the audience information.

2. A method as defined in claim 1, wherein receiving audience information comprises receiving at least one of a name, an age, an occupation, a gender, or an indication of technical competence.

3. A method as defined in claim 1, further comprising selecting an audience meter type based on the received audience information.

4. A method as defined in claim 3, wherein the audience meter type comprises at least one of a cabled meter or a non-cabled meter.

5. A method as defined in claim 4, wherein shipping the audience meter further comprises sending at least one audience meter connector if the audience meter is cabled.

6. A method as defined in claim 1, wherein configuring the audience meter comprises storing at least one instruction in a memory of the audience meter, the at least one instruction comprising at least one of an audience meter installation instruction or an audience meter training instruction.

7. (canceled)

8. (canceled)

9. (canceled)

10. A method as defined in claim 6, further comprising presenting the at least one instruction to the audience in response to a signal indicative of receipt of the audience meter.

11. A method as defined in claim 10, further comprising entering an installation mode in response to receiving the signal.

12. (canceled)

13. A method as defined in claim 1, further comprising placing the audience meter in an installation mode when the audience meter is received by an audience member.

14. A method as defined in claim 13, wherein the audience meter presents at least one installation instruction to the audience member.

15. (canceled)

16. A method as defined in claim 14, wherein the audience meter employs at least one sensor to confirm compliance of the at least one installation instruction.

17. A method as defined in claim 16, wherein the at least one sensor comprises an acoustic sensor, an optical sensor, a motion sensor, a voltage sensor, or a current sensor.

18. (canceled)

19. (canceled)

20. (canceled)

21. An audience installed audience meter comprising:
a memory to store an installation instruction; and
a setup director to present at least one of installation instructions in response to an input from at least one audience member.

22. A meter as defined in claim 21, further comprising an input/output (I/O) module to receive a request from the at least one audience member to present the user instructions.

23. (canceled)

24. A meter as defined in claim 21, further comprising an input/output (I/O) module to present the user instructions to the at least one audience member.

25. A meter as defined in claim 24, wherein the I/O module comprises at least one of a speaker to present the installation instructions, a port connector to transmit the instructions to an information presenting device, or a display to display the instructions to the at least one audience member.

26. (canceled)

27. (canceled)

28. A meter as defined in claim 21, further comprising a proximity detector to confirm compliance with the installation instructions.

29. A meter as defined in claim 28, wherein the proximity detector comprises an audio detector to determine a proximity to an information presenting device.

30. (canceled)

31. A meter as defined in claim 21, further comprising a processor to detect a line voltage, the setup director to invoke the at least one installation instruction to plug-in the meter when line voltage is absent.

32. (canceled)

33. (canceled)

34. (canceled)

35. (canceled)

36. (canceled)

37. (canceled)

38. (canceled)

39. A mailable meter comprising:
a housing;
an input device;
an output device; and
processor programmed to have a pre-shipment mode, a shipment mode, a setup mode, and a post-setup mode.

40. A mailable meter as defined in claim 39, further comprising configuring the mailable meter for a household member, the mailable meter configured in the pre-shipment mode.

41. (canceled)

42. (canceled)

43. (canceled)

44. A mailable meter as defined in claim 39, further comprising providing video overlay information to an audience member during at least one of the setup mode or the post-setup mode.

45. A mailable meter as defined in claim 44, wherein the video overlay information provided in the setup mode comprises at least one of textual installation instructions or installation diagrams.

46. A mailable meter as defined in claim 45, wherein the installation diagrams comprise at least one of a video splitter, an audio splitter, a radio frequency (RF) coaxial connector, or an audio/video (A/V) connector diagram.

47. (canceled)

48. A mailable meter as defined in claim 39, further comprising storing, during the setup mode, at least one of a voice signature, an image signature, or a radio frequency (RF) signal.

49. A mailable meter as defined in claim 48, wherein the at least one of the voice signature, the image signature, or the RF signal is associated with an audience member.

50. (canceled)

51. A mailable meter as defined in claim 39, wherein the processor executes in a sleep mode during the shipment mode of the mailable meter.

52. (canceled)

53. (canceled)

54. A mailable meter as defined in claim 39, further comprising playing audio setup instructions to an audience member in response to starting the setup mode.

55. A mailable meter as defined in claim 54, wherein the audio setup instructions are played via audio speakers built-in to the mailable meter.

56. A mailable meter as defined in claim 55, wherein the audio setup instructions request the audience member acknowledge receipt of the instructions via an audience member input button.

57. (canceled)

58. (canceled)

59. (canceled)

60. (canceled)

61. (canceled)

62. (canceled)

63. (canceled)

64. (canceled)

65. (canceled)

66. (canceled)

67. (canceled)
